(19) United States
(12) Patent Application Publication
(10) Pub. No.: US 2014/0143718 A1
(43) Pub. Date: May 22, 2014

(54) INFORMATION PROCESSING APPARATUS, PROFILE CREATION METHOD AND STORAGE MEDIUM

(71) Applicant: KABUSHIKI KAISHA TOSHIBA, Tokyo (JP)

(72) Inventors: Masanobu Kumakawa, Hidaka-shi (JP); Naoyuki Aizawa, Fussa-shi (JP)

(73) Assignee: KABUSHIKI KAISHA TOSHIBA, Tokyo (JP)

(21) Appl. No.: 13/971,623

(22) Filed: Aug. 20, 2013

(30) Foreign Application Priority Data
Nov. 22, 2012 (JP) 2012-256115

(51) Int. Cl. G06F 3/0481

(52) U.S. Cl. CPC G06F 3/0481
USPC 715/800

(57) ABSTRACT

According to one embodiment, an information processing apparatus includes a window rearrangement module and a profile creator. The window rearrangement module is configured to rearrange windows on a desktop screen based on a profile indicative of arrangement of the windows on the desktop screen. The profile creator is configured to create the profile by acquiring positions and sizes of the windows on the desktop screen.

### CROSS-REFERENCE TO RELATED APPLICATIONS

This application is based upon and claims the benefit of priority from Japanese Patent Application No. 2012-256115, filed Nov. 22, 2012, the entire contents of which are incorporated herein by reference.

### FIELD

Embodiments described herein relate generally to information processing techniques in a multiwindow-compatible information processing apparatus.

### BACKGROUND

In recent years, relatively small battery-powered information processing apparatuses, such as tablet computers or smartphones, have been widely used. However, quite a few notebook personal computers (PCs) which are also battery-powered information processing apparatuses have a larger monitor (with a higher resolution). External monitors for use with desktop PCs also have a tendency to become larger.

An operating system, which is a PC's basic software, is normally compatible with multiwindowing. As monitors become larger, more windows can be displayed side by side on the monitor. With this backdrop, for example, various mechanisms for enabling the user to divide the display area on the screen arbitrarily have been proposed.

Until now, the user has had to set, for example, how to divide the display area on the screen or the like using a graphical user interface (GUI) provided by a utility program. For example, the user was forced to do the work of setting division positions and sizes by, for example, moving a line displayed as a guide on the screen.

With this method, however, when windows are actually arranged, they might not be displayed as the user expected. In addition, the method has the problem of requiring time and effort to do the setting in the first place.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an external appearance of an information processing apparatus according to an embodiment.

FIG. 2 is an exemplary view showing a system configuration of the information processing apparatus according to the embodiment.

FIG. 3 is an exemplary view showing an example of a profile of a screen splitting utility program that operates on the information processing apparatus of the embodiment.

FIG. 4 is an exemplary first diagram to explain a basic operation of the screen splitting utility program that operates on the information processing apparatus of the embodiment.

FIG. 5 is an exemplary second diagram to explain the basic operation of the screen splitting utility program that operates on the information processing apparatus of the embodiment.

FIG. 6 is an exemplary third diagram to explain the basic operation of the screen splitting utility program that operates on the information processing apparatus of the embodiment.

FIG. 7 is an exemplary fourth diagram to explain the basic operation of the screen splitting utility program that operates on the information processing apparatus of the embodiment.

FIG. 8 is an exemplary diagram to explain the principle of creating a profile using the screen splitting utility program that operates on the information processing apparatus of the embodiment.

FIG. 9 is an exemplary functional block diagram to explain an operating principle of the screen splitting utility program that operates on the information processing apparatus of the embodiment.

FIG. 10 is an exemplary view showing an example of a confirmation screen displayed in creating a profile by the screen splitting utility program that operates on the information processing apparatus of the embodiment.

FIG. 11 is an exemplary view showing an example of an optional screen displayed in creating a profile by the screen splitting utility program that operates on the information processing apparatus of the embodiment.

FIG. 12 is an exemplary view showing a first diagram to explain an optional function related to the creation of a profile by the screen splitting utility program that operates on the information processing apparatus of the embodiment.

FIG. 13 is an exemplary view showing a second diagram to explain an optional function related to the creation of a profile by the screen splitting utility program that operates on the information processing apparatus of the embodiment.

FIG. 14 is an exemplary flowchart to explain the procedure for creating a profile by the screen splitting utility program that operates on the information processing apparatus of the embodiment.

### DETAILED DESCRIPTION

Various embodiments will be described hereinafter with reference to the accompanying drawings.

In general, according to one embodiment, an information processing apparatus includes a window rearrangement module and a profile creator. The window rearrangement module is configured to rearrange windows on a desktop screen based on a profile indicative of arrangement of the windows on the desktop screen. The profile creator is configured to create the profile by acquiring positions and sizes of the windows on the desktop screen.

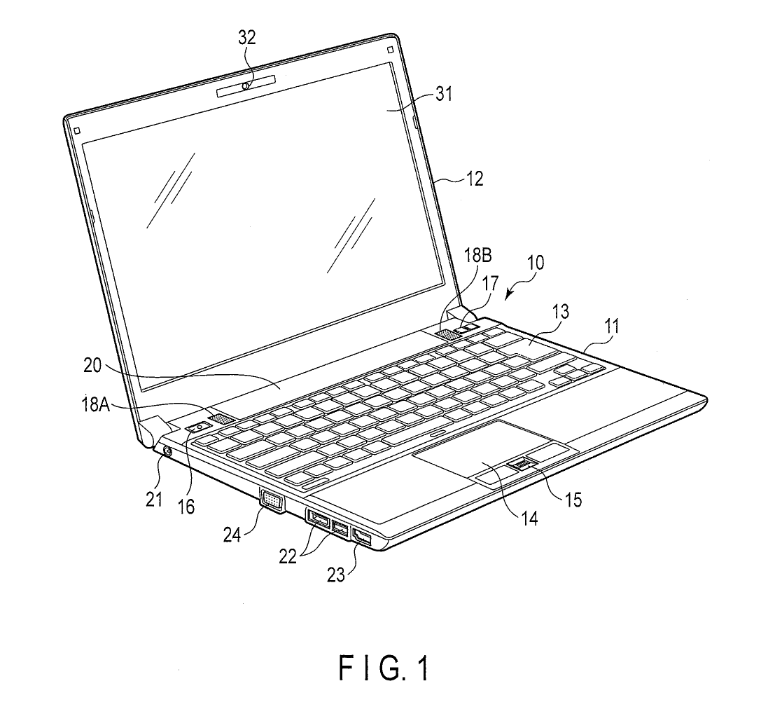

First, the configuration of an information processing apparatus of an embodiment will be explained with reference to FIG. 1. This information processing apparatus may be realized in the form of a notebook personal computer, a tablet computer, or other various types of information processing apparatus. Hereinafter, suppose the information processing apparatus has materialized as a notebook personal computer 10.

FIG. 1 is an exemplary perspective view of the computer 10 with a display unit opened, when seen from the front. The computer 10 is configured to receive power from a battery 20. The computer 10 includes a computer body 11 and a display unit 12. In the display unit 12, such a display device as a liquid-crystal display (LCD) 31 has been incorporated. In addition, in the upper part of the display unit 12, a camera (Webcam) 32 has been arranged.

The display unit 12 is mounted to the computer body 11 so as to be rotatable freely between an opened position where the top face of the computer body 11 is exposed and a closed position where the top face of the computer body 11 is covered with the display unit 12. The computer body 11 has a thin box-like chassis. On the top face of the chassis, there are provided a keyboard 13, a touchpad 14, a fingerprint sensor 15, a power switch 16 for turning the computer 10 on or off, several function buttons 17, and speakers 18A, 18B.

In addition, the computer body 11 is further provided with a power connector 21. The power connector 21 is provided on the side of the computer body 11, for example, on the left side. An external power supply unit is connected to the power connector 21 in a detachable manner. An AC adaptor may be used as the external power supply unit. The AC adaptor is a power supply unit that converts commercial power (AC power) into DC power.

The battery 20 is installed, for example, in the back end part of the computer body 11 in a detachable manner. The battery 20 may be a battery built into the computer 10.

The computer 10 is activated by electricity from an external power supply unit or from the battery 20. If the external power supply unit has been connected to the power connector 21 of the computer 10, the computer 10 is activated by the external power supply unit. Electricity from the external power supply unit is also used to charge the battery 20. During a period when the external power supply is not connected to the power supply connector 21 of the computer 10, the computer 10 is activated by electricity from the battery 20.

In addition, the computer body 11 is further provided with several USB ports 22, a High-definition Multimedia Interface (HDMI) output terminal 23, and an RGB port 24.

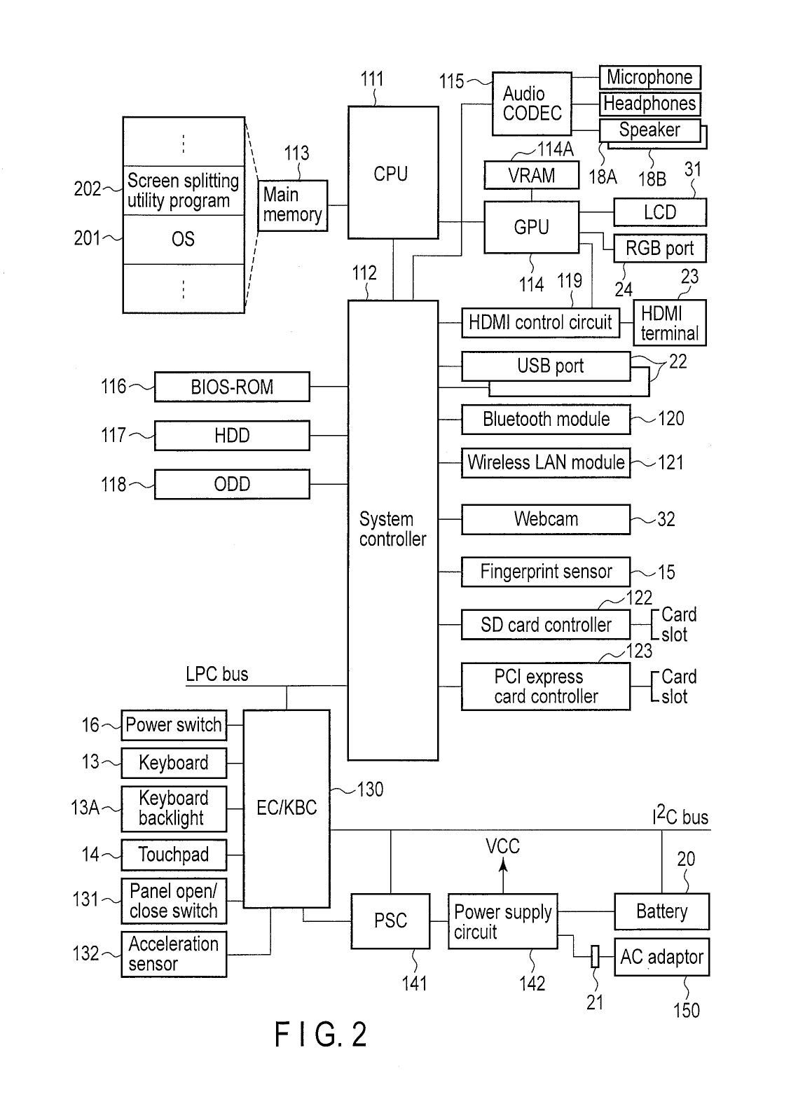

FIG. 2 is an exemplary view showing a system configuration of the computer 10. The computer 10 includes a CPU 111, a system controller 112, a main memory 113, a graphics processing unit (GPU) 114, a sound codec 115, a BIOS-ROM 116, a hard disk drive (HDD) 117, an optical disk drive (ODD) 118, a Bluetooth (registered trademark) module 120, a wireless LAN module 121, an SD card controller 122, a PCI EXPRESS card controller 123, an embedded controller/keyboard controller IC (EC/KBC) 130, a keyboard backlight 13A, a panel open/close switch 131, an acceleration sensor 132, a power supply controller (PSC) 141, and a power supply circuit 142.

The CPU 111 is a processor that controls the operation of each component of the computer 10. The CPU 111 executes various items of software loaded from the HDD 117 into the main memory 113. The items of software include an operating system (OS) 201 and various application programs. The items of software include a screen splitting utility program 202 described later.

In addition, the CPU 111 also executes a Basic Input/Output System (BIOS) stored in the BIOS-ROM 116, a nonvolatile memory. The BIOS is a system program for hardware control.

The GPU 114 is a display controller that controls the LCD 31 used as a display monitor of the computer 10. The GPU 114 generates a display signal (an LVDS signal) to be supplied to the LCD 31 from display data stored in a video memory (VRAM) 114A. In addition, the GPU 114 can also generate an analog RGB signal and an HDMI video signal from the display data. The analog RGB signal is supplied to an external display via the RGB port 24. The HDMI output terminal 23 can send an HDMI video signal (uncompressed digital video signal) and a digital audio signal to an external display with a signal cable. An HDMI control circuit 119 is an interface for sending the HDMI video signal and digital audio signal to an external display via the HDMI output terminal 23.

The system controller 112 is a bridge device that makes a connection between the CPU 111 and each component. The system controller 112 includes a serial ATA controller for controlling the hard disk drive (HDD) 117 and optical disk drive (ODD) 118. In addition, the system controller 112 performs communication with each device on a Low Pin Count (LPC) bus.

The EC/KBC 130 is connected to the LPC bus. The EC/KBC 130, power supply controller (PSC) 141, and battery 20 are connected to one another via a serial bus such as an I²C bus.

The EC/KBC 130, which is a power management controller for managing the power of the computer 10, is implemented as a single-chip microcomputer that includes, for example, a keyboard controller that controls the keyboard (KB) 13, touchpad 14, and the like. The EC/KBC 130 includes the function of turning on or off the computer 10 in response to the user operation of the power switch 16. The on/off control of the computer 10 is performed by the cooperation of the EC/KBC 130 with the power supply controller (PSC) 141. When having received an ON signal transmitted from the EC/KBC 130, the power supply controller (PSC) 141 controls the power supply circuit 142 to turn on the computer 10.

In addition, when having received an OFF signal transmitted from the EC/KBC 130, the power supply controller (PSC) 141 controls the power supply circuit 142 to turn off the computer 10. Even during a period when the computer 10 is off, the EC/KBC 130, power supply controller (PSC) 141, and power supply circuit 142 are operated by electricity from the battery 20 or AC adapter 150.

In addition, the EC/KBC 130 can turn on or off a keyboard backlight 13A arranged on the back face of the keyboard 13. Moreover, the EC/KBC 130 is connected to the panel open/close switch 131 configured to detect the opening and closing of the display unit 12. Even when the panel open/close switch 131 has detected the opening of the display unit 12, the EC/KBC 130 can turn on the computer 10.

The power supply circuit 142 generates power (operating power) to be supplied to each component using power from the battery 20 or power from the AC adapter 150 connected as an external power supply to the computer body 11.

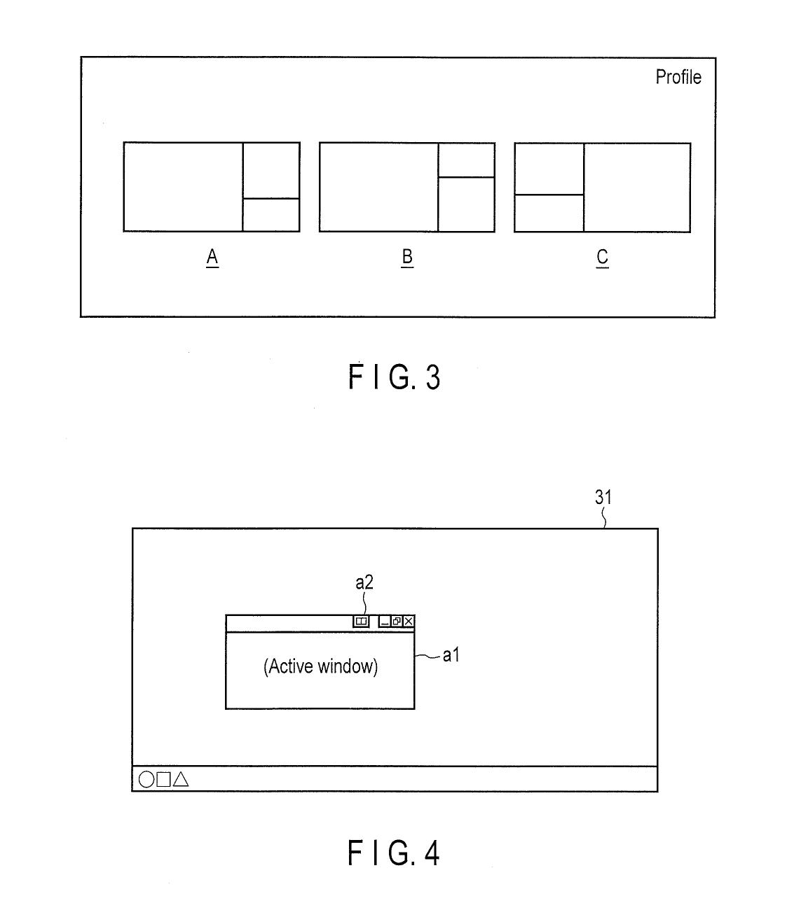

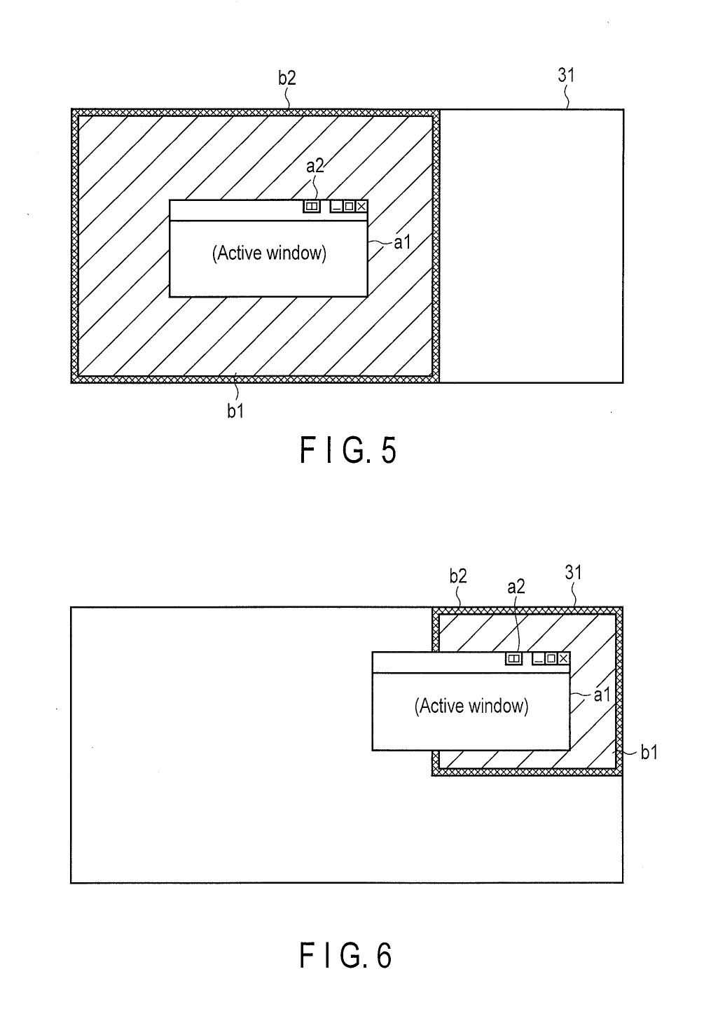

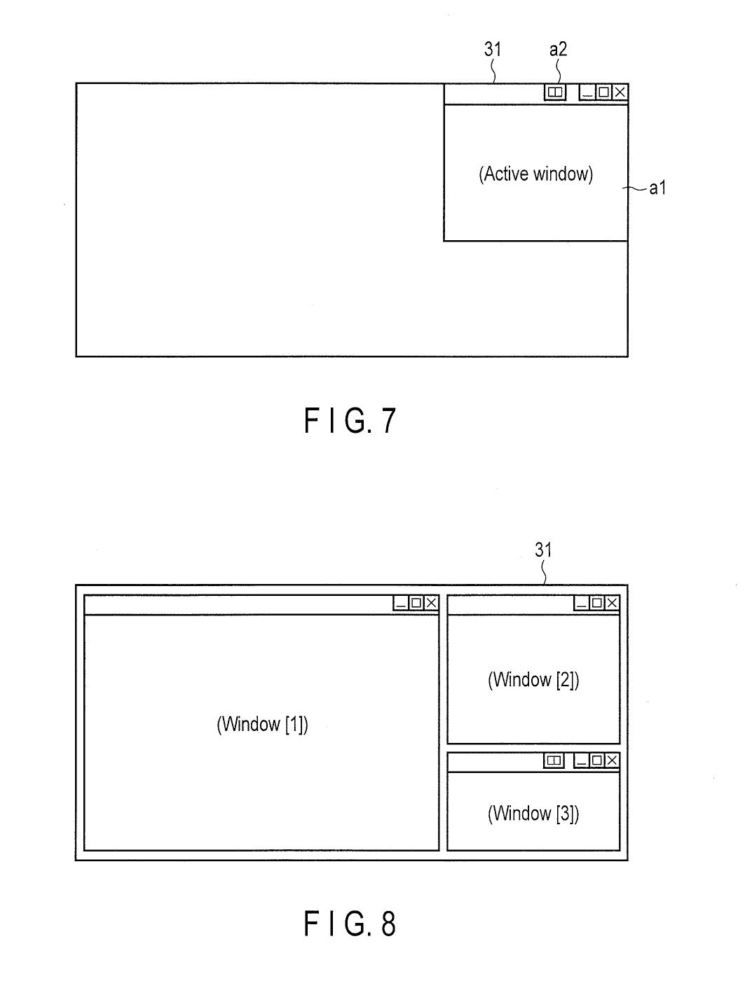

Next, the basic function of the screen splitting utility program 202 that runs on the computer configured as described above will be explained with reference to FIG. 3, FIG. 4, FIG. 5, FIG. 6 and FIG. 7.

The screen splitting utility program 202 is a user-assistance program that assists the rearrangement of windows on a desktop screen using a profile where the way windows are arranged on the desktop screen has been defined. In addition, the screen splitting utility program 202 is set as a resident program.

Now, suppose, as shown in FIG. 3, three areas in which windows are to be arranged have been defined in each region on the desktop screen and three profiles, “A,” “B,” “C,” differing from one another in the arrangement pattern, have been defined. Of these profiles, suppose “A” has been applied.

FIG. 4 shows a state where, for example, some application program has been started and a window a1 for the application program has been arranged on the desktop screen displayed on the LCD 31. That is, the window a1 is in an active state (an active window).

The screen splitting utility program 202 acquires information on an active window, more specifically, the position and size from the OS 201 and displays an icon a2 in a specific position in the active window. For example, when two windows have been arranged on the desktop screen, the screen splitting utility program 202 displays the icon a2 only in an active window. Therefore, when a first window has changed from an active window to an inactive window, that is, when a second window has changed from an inactive window to an active window, the screen splitting utility program 202 performs the process of deleting the icon a2 in the first window and displaying the icon a2 in the second window.

Furthermore, the screen splitting utility program 202 acquires information on the operation of the touchpanel 14 from the OS 201. When the operation corresponds to the display position of the icon a2, the screen splitting utility program 202 performs the process of rearranging the active window (in which the icon a2 has been displayed).

When, for example, the left button of the touchpad 14 is pressed and held and is moved (drag operation), with a pointer indicating the icon a2, the screen splitting utility program 202 performs specific image processing so as to display a virtual window b2 transparently in an area b1 as a guide (in such a manner that the desktop screen can be seen through) in order to cause the user to recognize the area b1 in which the window a1 is to be arranged.

The area b1 in which the window a1 is to be arranged is set as an area corresponding to, for example, the display position of the icon a2. When wanting to arrange the window a1 in an upper right area, the user performs a drag operation so as to cause the icon a2 to move to the upper right area. When the drag operation has changed the area b1 in which the window a1 is to be arranged, the screen splitting utility program 202 changes an area to be subjected to specific image processing whereby the virtual window b2 is displayed transparently as a guide (in such a manner that the desktop screen can be seen through) as shown in FIG. 6. As a result, the user recognizes that the arrangement destination of the window a1 can be set to a desired area.

After having set the arrangement destination of the window a1 to the desired area, the user releases, for example, the left button of the touchpad 14. In response to this, the screen splitting utility program 202 issues a command to arrange the window a1 in the upper right area to the OS 201. As a result, as shown in FIG. 7, the window a1 can be rearranged in the upper right area desired by the user. In other words, just manipulating the icon a2, the user can easily rearrange a window in any one of the areas defined in the profile.

When a drag operation has been performed so as to move the window a1 in a state where the pointer does not indicate the icon a2, the screen splitting utility program 202 performs display control of the icon a2 so as to follow the movement on the basis of information on the active window acquired from the OS 201.

The profile is normally set by the user via a GUI provided by a utility program (such as the screen splitting utility program 202 in this case). For example, the user has done the work of setting division positions and sizes by moving a line displayed as a guide on the screen. With this method, however, when windows have been actually arranged, they might not be displayed as the user expected. Moreover, it requires time and effort to do the setting in the first place.

With this backdrop, the computer 10 is configured to be capable of setting the profile efficiently, that is, of setting the arrangement of windows on the desktop screen efficiently. Hereinafter, this will be explained in detail.

Suppose the user is thinking of creating a profile that defines a window arrangement pattern as shown by “A” of FIG. 3. In this case, for example, as shown in FIG. 8, the user actually arranges three windows on the desktop screen displayed on the LCD 31 and presses a function key on the keyboard 13 previously allocated to, for example, the screen splitting utility program 202. The pressing of the function key may be, for example, the pressing of a second key, with a first key remaining pressed.

When having been informed by the OS 201 that the function key has been pressed, the screen splitting utility program 202 acquires, from the OS 201, information on the three windows arranged on the desktop screen, that is, information on the positions and sizes. On the basis of the information on the three windows arranged on the desktop screen acquired from the OS 201, the screen splitting utility program 202 creates a profile that defines the arrangement pattern of windows as shown by “A” of FIG. 3. A profile may be created not only by arranging a window and pressing the function key but also by selecting “Profile creation” from a menu provided as a GUI by the screen splitting utility program 202.

With the above method, a profile is created on the basis of the positions and sizes of the windows actually arranged on the desktop screen by the user and therefore the windows can be rearranged as the user expected. For example, suppose, when, for example, doing a certain work, the user uses, for example, three applications, a browser, word-processing software, and spreadsheet software, concurrently and arranges the three application program windows in almost the same places. In such a case, just pressing a function key once, with each window arranged in a desired position, the user can create a profile for the work. From this time on, for example, when starting a work, the user can rearrange each window in a desired area easily.

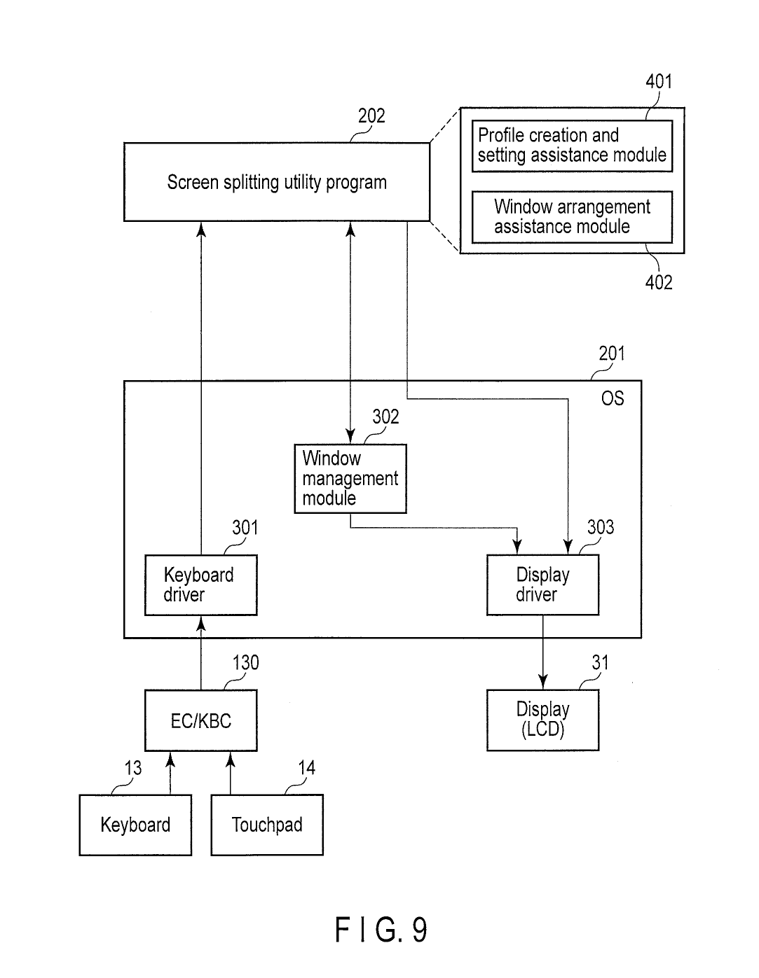

FIG. 9 is an exemplary functional block diagram to explain an operating principle of the screen splitting utility program 202.

As shown in FIG. 9, the screen splitting utility program 202 includes a profile creation and setting assistance module 401 and a window arrangement assistance module 402.

The profile creation and setting assistance module 401 is a module that acquires information on windows arranged on the desktop screen from a window management module 302 of the OS 201 and creates a profile. In addition, the profile creation and setting assistance module 401 provides a user interface for selecting a desired one from a plurality of profiles. The window arrangement assistance module 402 is a module that acquires information on the active window a1 from the window management module 302 of the OS 201 and displays the icon a2 in the active window a1 and rearranges the active window a1 in response to the manipulation of the icon a2.

First, the operating principle of the window arrangement assistance module 402 will be explained briefly.

The window arrangement assistance module 402 asks the OS 201 to inform occurrence of an event associated with an active window and to transfer information on the window, when a certain window has become active, when the position or size of an active window has changed, or when an event related to an active window has occurred. In addition, the window arrangement assistance module 402 asks the OS 201 to transfer the manipulation information when the touchpad 14 has been manipulated. This enables the window arrangement assistance module 402 to acquire information on the active window from the window management module 302 of the OS 201 and manipulation information on the touchpad 14 from a keyboard driver 301 of the OS 201.

When having acquired information on the active window from the window management module 302 of the OS 201, the window arrangement assistance module 402 removes the icon a2 drawn so as to be superimposed on a window that was active until then (if the icon a2 is displayed in the window that has become inactive), and draws an icon a2 so as to superimpose the icon a2 on a window that has become active and uses the OS 201 to cause a display driver 303 to display screen data about a newly drawn icon a2 on the LCD 31.

Furthermore, when having acquired information on the manipulation of the touchpad 14 from the keyboard driver 310 of the OS 201, the window arrangement assistance module 402 first checks whether the manipulation corresponds to the display position of the icon a2. If the manipulation corresponds to the display position of the icon a2, the window arrangement assistance module 402 causes, via the OS 201, the display driver 303 to perform specific image processing so as to display a virtual window b2 in an area b1 as a guide and rearranges, via the window management module 302, windows in the area b1.

The profile may be configured to be capable of managing the identifiers of application programs in such a manner that the identifiers are caused to correspond to individual areas. Then, when an application program has been started and a window (an active window) for the application program has been provided, if the identifier of the application program has been managed by the profile, the window arrangement assistance module 402 may automatically rearrange the window for the application program in an area to which the identifier of the application program in an area defined in the profile has been caused to correspond.

Next, the operating principle of the profile creation and setting assistance module 401 will be explained.

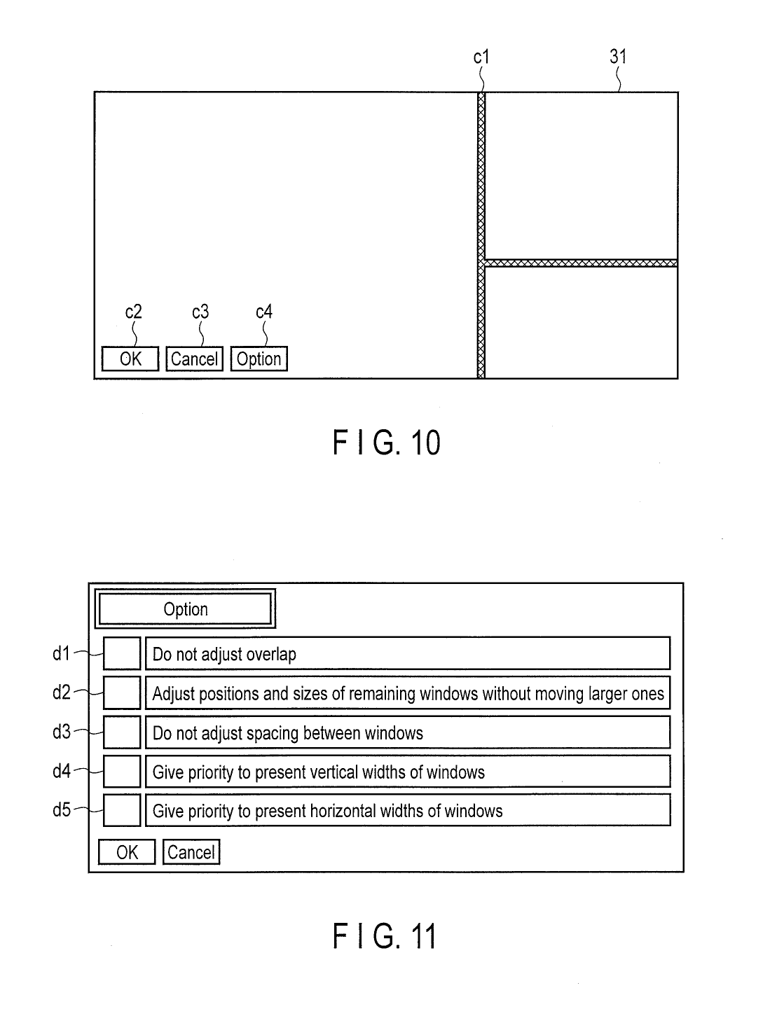

When having been informed by the keyboard driver 301 of the OS 201 that a function key allocated to the screen splitting utility program 202 has been pressed, the profile creation and setting assistance module 401 acquires information on the windows arranged on the desktop screen from the window management module 302 of the OS 201. Having acquired the information, the profile creation and setting assistance module 401 makes adjustments, including the reduction of the spacing between windows and the removal of the overlap between windows, and presents contents defined as a profile to the user by displaying, for example, a confirmation screen using an object c1 as shown in FIG. 10. The object c1 displayed on the confirmation screen represents an area in actually rearranging windows using the profile.

Adjustments, such as the reduction of the spacing between windows and the removal of the overlap between windows, are made by, for example, increasing the widths of both windows to the central part of the spacing and by decreasing the widths of both windows to the central part of the overlapping part.

Because the profile creation and setting assistance module 401 includes adjustment functions of decreasing the spacing between windows and removing the overlap between windows, the user has only to arrange windows in approximate positions when creating a profile.

As shown in FIG. 10, the profile creation and setting assistance module 401 displays three software buttons (c2, c3, c4) operable on the touchpanel 14 on the confirmation screen. Button c2 is a button that is operated when the user agrees that a profile should be created so as to include contents displayed as a guide in the object c1. When a click operation is performed with the pointer indicating button c2, the profile creation and setting assistance module 401 creates a profile that defines a window arrangement pattern displayed as a guide in the object c1 on the confirmation screen. Button c3 is a button that is operated when the user does not agree that a profile should be created so as to include contents displayed as a guide in the object c1. When a click operation is performed with the pointer indicating button c3, the profile creation and setting assistance module 401 terminates the process without creating a profile.

Button c4 is a button that is operated when the user sets the way the arrangement of windows is adjusted. The profile creation and setting assistance module 401 basically makes adjustments, such as the reduction of the spacing between windows and the removal of the overlap between windows, as described above. The user can customize the adjustment rule variously by manipulating button c4.

When a click operation has been performed, with the pointer indicating button c4, the profile creation and setting assistance module 401 displays an optional screen of FIG. 11. As shown in FIG. 11, the profile creation and setting assistance module 401 displays five check boxes (d1, d2, d3, d4, d5) operable on the touchpad 14 on the optional screen.

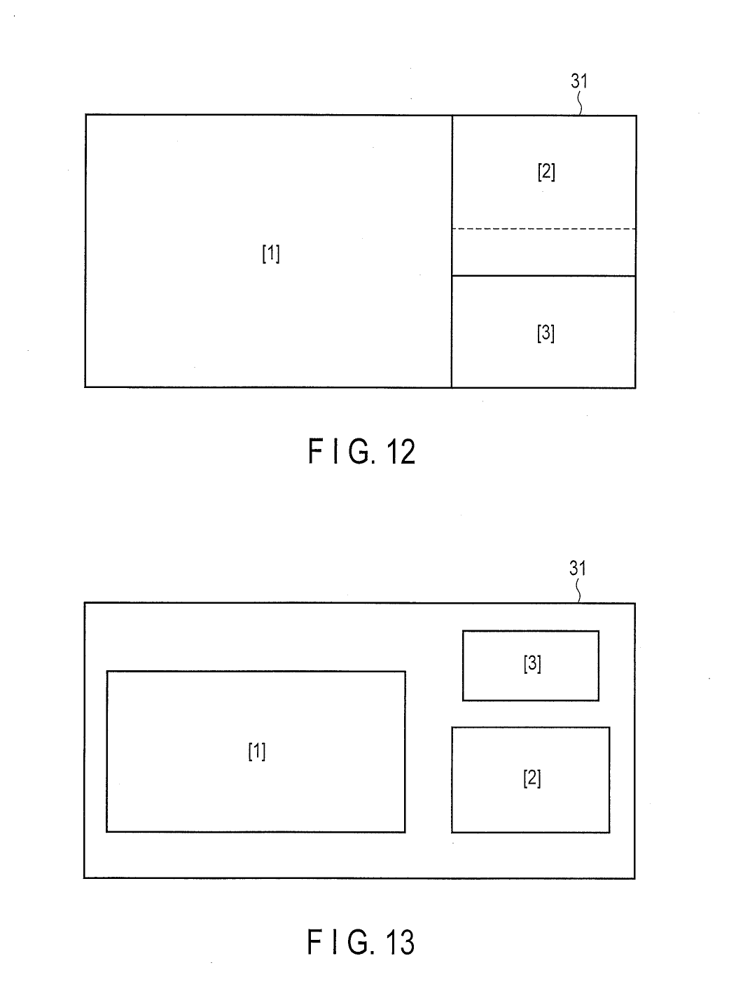

When a check box d1 has been checked, for example, a profile as shown in FIG. 12 can be created. With this profile, window [2] and window [3] can be rearranged in such a manner that they are stacked one on top of the other vertically. This is effective in securing the sizes of window [2] and window [3] to some degree. Making active one of the windows the user want to place in the upper part enables the vertical relation between the windows to be reversed as needed.

When a check box d2 has been checked, adjustments can be made giving priority to the arrangement of a larger window. For example, when there is a spacing between two windows, only the width of a window smaller in size is increased. When two windows overlap with each other, only the width of a window smaller in size is decreased.

When a check box d3 has been checked, for example, a profile as shown in FIG. 13 can be created. This is effective in arranging windows [1] to [3] with some spacing between them. Checking check box d3 with check box d1 enables a profile according to the arrangement of windows at the time to be created without any measurement.

In addition, when not wanting to change one of the vertical width and the horizontal width of a window as much as possible, the user checks either check box d4 or d5. In this case, as a rule, only the width of the other is adjusted. For example, when windows overlap with each other vertically (with check box d4 checked) or horizontally (with check box d5 checked), an adjustment is made so as to remove the overlap by moving the windows vertically or horizontally in a possible range, not by decreasing the widths of the windows.

As described above, the profile creation and setting assistance module 401 includes a user interface for customizing the window arrangement adjusting rule as needed. When a check box has been checked on the optional screen of FIG. 11 and the OK button has been operated, the profile creation and setting assistance module 401 makes an adjustment again and displays the result on the confirmation screen of FIG. 10 to the user (the display position of the object c1 is changed). When the OK button on the confirmation screen has been operated, the profile creation and setting assistance module 401 creates a profile on the basis of the readjusted contents.

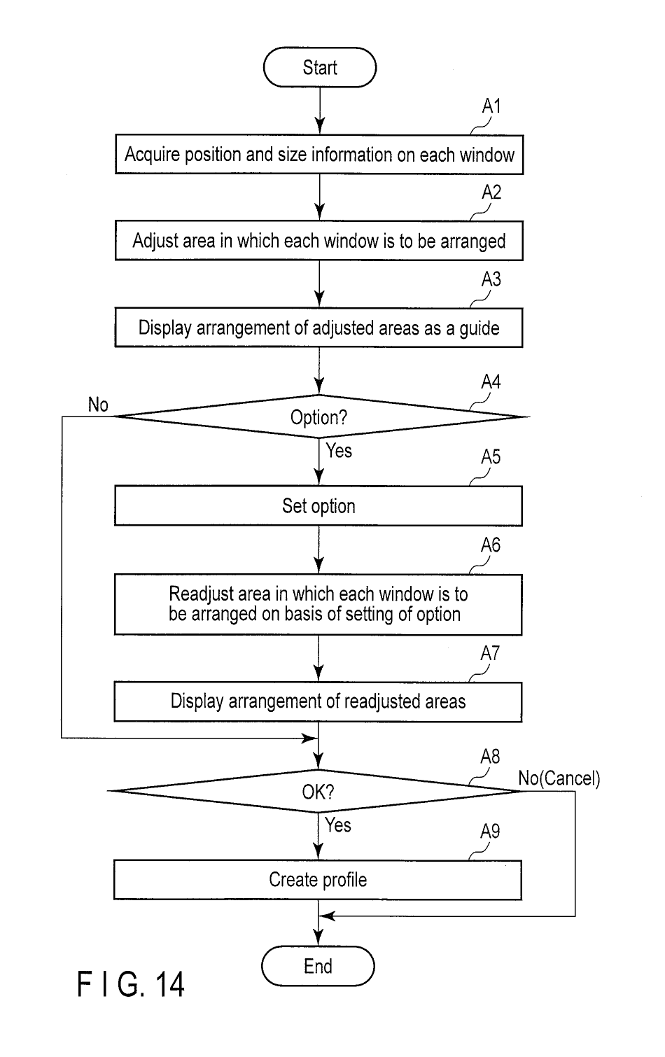

FIG. 14 is an exemplary flowchart to explain the procedure for creating a profile with the profile creation and setting assistance module 401.

First, the profile creation and setting assistance module 401 acquires information on the windows arranged on the desktop screen from the window management module 302 of the OS 201 (block A1). Next, on the basis of this information, the profile creation and setting assistance module 401 adjusts areas in which the windows are to be arranged (block A2) and displays the object c1 indicating the arrangement of the adjusted areas as a guide (block A3).

When an option button has been operated (YES in block A4), the profile creation and setting assistance module 401 performs the setting of an option (block A5) and, on the basis of the setting of the option, readjusts areas in which the windows are to be arranged (block A6). The profile creation and setting assistance module 401 displays the object c1 indicating the arrangement of the readjusted areas as a guide (block A7).

When the OK button has been operated (YES in block A8), the profile creation and setting assistance module 401 creates a profile that defines the arrangement of the adjusted or readjusted windows (block A9). In contrast, when a cancel button has been operated (NO in block A8), the profile creation and setting assistance module 401 terminates the process without creating a profile.

As described above, the computer 10 makes it possible to set the arrangement of windows on the desktop screen efficiently.

All the operating procedures of the embodiment can be realized with software. Therefore, the software can be introduced into an ordinary computer via a computer-readable storage medium, thereby realizing the same effect as that of the embodiment easily.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a window rearrangement module configured to rearrange windows on a desktop screen based on a profile indicative of arrangement of the windows on the desktop screen; and
a profile creator configured to create the profile by acquiring positions and sizes of the windows on the desktop screen.

2. The apparatus of claim 1, further comprising an adjuster configured to adjust the arrangement of the windows based on the positional relationship between the windows.

3. The apparatus of claim 2, further comprising an option acceptor configured to accept selection of a rule on adjustment of window arrangement with the adjuster.

4. The apparatus of claim 2, wherein the adjuster is configured to adjust the arrangement of the windows so as to decrease spacing between the windows.

5. The apparatus of claim 4, wherein the adjuster is configured to change, when adjusting arrangement of a first window and a second window smaller in size than the first window based on a positional relationship between the first window and the second window, a position and a size of the second window without changing a position and a size of the first window.

6. The apparatus of claim 2, wherein the adjuster is configured to adjust the arrangement of the windows so as to remove an overlap between windows.

7. The apparatus of claim 6, wherein the adjuster is configured to change, when adjusting arrangement of a first window and a second window smaller in size than the first window based on a positional relationship between the first window and the second window, a position and a size of the second window without changing a position and a size of the first window.

8. The apparatus of claim 2, wherein the adjuster is configured to adjust the arrangement of the windows while maintaining an overlap between the windows.

9. The apparatus of claim 8, wherein the adjuster is configured to change, when adjusting arrangement of a first window and a second window smaller in size than the first window based on a positional relationship between the first window and the second window, a position and a size of the second window without changing a position and a size of the first window.

10. The apparatus of claim 2, wherein the adjuster is configured to adjust the arrangement of the windows by changing sizes of the windows in one of a vertical direction and a horizontal direction without changing sizes of the windows in the other direction.

11. The apparatus of claim 1, wherein:
the profile is configured to manage identifiers of application programs for each area on the desktop screen where the windows are arranged, and
the window rearrangement module is configured to rearrange the windows secured on the desktop screen for the application programs based on the profile when an application program whose identifier is managed by the profile is activated.

12. A profile creation method in an information processing apparatus configured to rearrange windows on a desktop screen based on a profile indicative of arrangement of the windows on the desktop screen, the method comprising:
creating the profile by acquiring positions and sizes of the windows on the desktop screen.

13. A computer-readable, non-transitory storage medium comprising a computer program configured to be executed by a computer, the computer program configured to control the computer to rearrange windows on a desktop screen based on a profile indicative of arrangement of the windows on the desktop screen,
wherein the computer comprises a profile creator configured to create the profile by acquiring positions and sizes of the windows on the desktop screen.
